(19) United States
(12) Patent Application Publication
(10) Pub. No.: US 2019/0114513 A1
(43) Pub. Date: Apr. 18, 2019

(54) BUILDING COGNITIVE CONVERSATIONAL SYSTEM ASSOCIATED WITH TEXTUAL RESOURCE CLUSTERING

(71) Applicant: International Business Machines Corporation, Armonk, NY (US)

(72) Inventors: Li Jun Mei, Beijing (CN); Qi Cheng Li, Beijing (CN); Jian Wang, Beijing (CN); Yi Peng Yu, Beijing (CN); Xin Zhou, Beijing (CN)

(21) Appl. No.: 15/782,876

(22) Filed: Oct. 13, 2017

(51) Int. Cl. G06K 9/62; G06K 9/00; G06F 17/27

(52) U.S. Cl. CPC G06K 9/6263; G06K 9/00456; G06F 17/274; G06F 17/2785; G06K 9/6218

(57) ABSTRACT

In an approach for improving the identification of textual resources that contain unrelated and imprecise contents to improve a user's understanding of a conversational system, one or more computer processors extracts a domain keyword from a domain model and retrieves a distributed representation associated with the domain keyword. The one or more computer processors generates a cluster resource based on the distributed representation and creates a resource vector associated with the cluster resource by calculating the resource vector. The one or more computer processors applies the resource vector to a conversational system and simulates a runtime user interaction based on reinforcement learning of the resource vector to further label and refine resource vector. The one or more computer processors outputs a labeled and refined resource vector to aid in understanding of the conversational system.

### BACKGROUND OF THE INVENTION

The present application generally relates to data processing, and more specifically, to textual conversational system.

The usage of big data has brought significant improvement in statistical text understanding. However, textual resources (e.g., professional documents, amateur documents, and forum discussion) varies in terms of quality which provides a challenge to understanding and interpretation of these resources. For example, on web forum discussion dealing with computer issues, there are several disjointed information presented by the original poster (OP) and responses from the users. The following passage is an excerpt from such a site:
HORRIBLE connectivity problems WinXP ×64 Pro
Wow, where to begin . . . .
eMachines M6805, newly, and freely, refurbished by Gateway.
WinXP Home, registered, was so unbearable (couldnt even install DX9.0c because the drivers werent signed? downloaded them from microshaft anywho) that I HAD to install something else. Went with WinXP ×64 PRO, a veritable speed demon. I would have went with XP PRO, but the game i usually play (old game from '97, tribes) does not like winxp . . . .
Anywho, that's where I'm at. I have installed very little. Broadcom's wireless utilities, modified catalyst drivers (to allow 1280×800), VLC Media Player, Shareaza, Azureus, and K-Lite Full Codec Pack . . . that's it.

Information posted on the websites contains information that can be categorized into sub components (e.g., a classifiers, an entity, and an emotion content). Emotion contents can be defined as components that deal with human emotions and that has very little value to diagnosing the problem. For example, (referring to the preceding paragraph), the emotion content from the sentence above is “ . . . was so unbearable . . . ” and “veritable speed demon.” Given, the various elements that makes up the conversation above, there are several elements (e.g., emotion content, etc.) that tend to provide imprecise and erroneous information. Hence, this tends to lead to a faulty understanding and mishandling of the issue posted by the OP.

Additionally, due to the different capabilities of textual understanding by different users (e.g., professor vs. farmer), it is impossible for one conversational system to apply same strategy and data resources for all kinds of users. In other words, it is necessary to first consider the capabilities of textual understanding in building a high-quality conversational system. Therefore, there is a need to sift through all the textual information by textual resource “clustering” to remove imprecise elements within the conversation in order to serve various types of users.

### SUMMARY

A computer-implemented method for improving the identification of textual resources that contain unrelated and imprecise contents to improve a user's understanding of a conversational system, the method comprising: extracting, by one or more computer processors, a domain keyword from a domain model; retrieving, by the one or more computer processors, a distributed representation associated with the domain keyword; generating, by the one or more computer processors, a cluster resource based on the distributed representation; creating, by the one or more computer processors, a resource vector associated with the cluster resource by calculating the resource vector; applying, by the one or more computer processors, the resource vector to a conversational system; simulating, by the one or more computer processors, a runtime user interaction based on reinforcement learning of the resource vector to further label and refine resource vector; and outputting, by the one or more computer processors, a labeled and refined resource vector to aid in understanding of the conversational system.

### BRIEF DESCRIPTION OF THE DRAWINGS

FIG. 1A is a functional block diagram illustrating conversational server data processing environment 100, in accordance with an embodiment of the present invention;

FIG. 1B is a functional block diagram depicting conversational component 111 in accordance with an embodiment of the present invention;

FIG. 2A depicts a typical textual flow illustrating the common issues regarding conversational system in accordance with an embodiment of the present invention;

FIG. 2B is a diagram illustrating a statistical spoken dialogue system structure, in accordance with an embodiment of the present invention;

FIG. 3A illustrates a simplified implementation of conversational component 111 in accordance with an embodiment of the present invention;

FIG. 3B is an illustration of resource vector 310, in accordance with an embodiment of the present invention;

FIG. 4 is a flowchart depicting operational steps of conversational component 111 in accordance with an embodiment of the present invention; and

FIG. 5 depicts a block diagram of components of the server computer executing the program within the circuit design data processing environment of FIG. 1, in accordance with an embodiment of the present invention.

### DETAILED DESCRIPTION

Embodiments of the present invention recognize that improvements to cognitive conversational system can be made by using the following key innovations: textual resource clustering, categorizing users and reinforcement learning (RL). Textual or data resource clustering is a unique way to cluster the resources (e.g., candidate resources) based on their representative capability, rather than simple coverage such as words or phrases. In addition, an improved method of existing art (e.g., statistically spoken dialogue structure system, dialogue modeling, etc.) to categorize users into various types of groups based on their understanding capability, rather than using simple metrics such as words or phrases. Furthermore, through reinforcement learning (RL), using any method in the existing art (e.g., optimal control, state-value function, temporal difference, etc.), the invention can dynamically refine resource vectors to gain a more precise and accurate representation of the conversational system.

Textual resource clustering and categorizing users can be further explained below:

A method to cluster resources (combine a set of extended resources with basic resource) into resource vectors based on their representative capability, that is, calculating the distance (e.g., vector distance) of distributed representation for domain-specific keywords, rather than simple coverage such as words or phrases. Basic resources can be defined as a set of resources consisting of at least a technical document and an official reply. Extended resources can be defined as a set of resources consisting at least a website and a forum.

A method to calculate the distributed representations of each resource vector, and then apply each resource vector into conversational system, and generate one bot instance based on each resource vector.

Furthermore, the present invention automatically identify textual resources that contain unrelated, imprecise, or erroneous contents is critical to help improve the understanding capability of conversational system. The present invention can be used by, but is not limited to, a technical support websites and an online website requiring extensive dialogues (e.g., medical self-help websites). Implementation of embodiments of the invention can take a variety of forms, and exemplary implementation details are discussed subsequently with reference to the Figures.

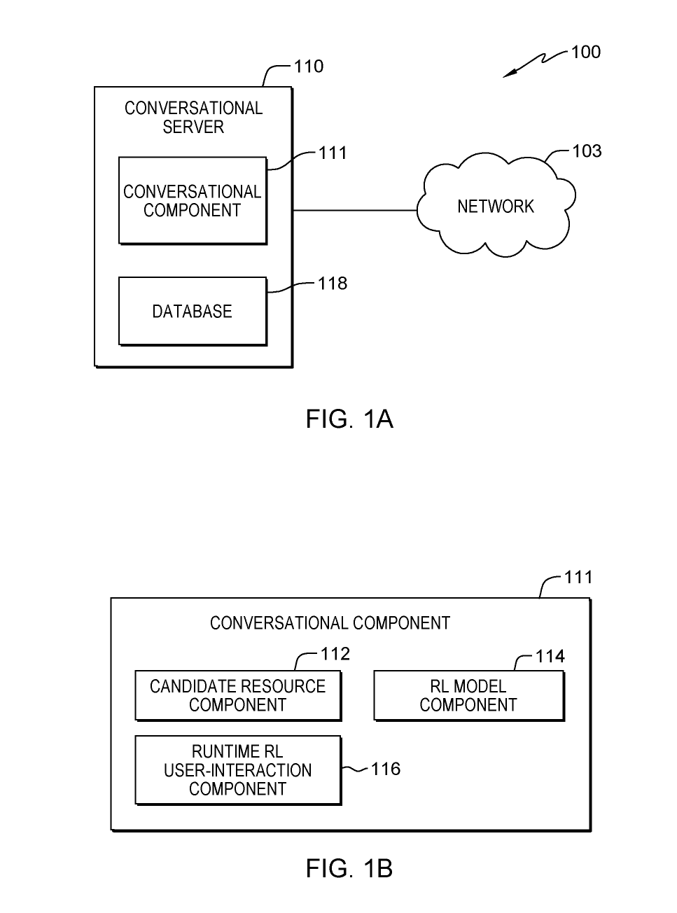

FIG. 1 is a functional block diagram illustrating a cognitive conversational system processing data processing environment, generally designated 100, in accordance with one embodiment of the present invention. FIG. 1 provides only an illustration of one implementation and does not imply any limitations with regards to the environments in which different embodiments may be implemented. Many modifications to the depicted environment may be made by those skilled in the art without departing from the scope of the invention as recited by the claims.

Cognitive conversational system processing data processing environment 100 includes conversational server 110 all interconnected over network 103. Network 103 can be, for example, a telecommunications network, a local area network (LAN), a wide area network (WAN), such as the Internet, or a combination of the three, and can include wired, wireless, or fiber optic connections. Network 103 can include one or more wired and/or wireless networks that are capable of receiving and transmitting data, voice, and/or video signals, including multimedia signals that include voice, data, and video information. In general, network 103 can be any combination of connections and protocols that will support communications between conversational server 110 and other computing devices (not shown) within cognitive conversational system processing data processing environment 100.

Conversational server 110 can be a standalone computing device, a management server, a web server, a mobile computing device, or any other electronic device or computing system capable of receiving, sending, and processing data. In other embodiments, conversational server 110 can represent a server computing system utilizing multiple computers as a server system, such as in a cloud computing environment. In another embodiment, conversational server 110 can be a laptop computer, a tablet computer, a netbook computer, a personal computer (PC), a desktop computer, a personal digital assistant (PDA), a smart phone, or any other programmable electronic device capable of communicating with, and other computing devices (not shown) within cognitive conversational data processing environment 100 via network 103. In another embodiment, conversational server 110 represents a computing system utilizing clustered computers and components (e.g., database server computers, application server computers, etc.) that act as a single pool of seamless resources when accessed within cognitive conversational system processing environment 100. Conversational server 110 includes conversational component 111 and database 118.

Conversational component 111 enables building a robust cognitive conversation system utilizing textual resource clustering. In the depicted embodiment, conversational component 111 resides on conversational server 110.

Database 118 is a repository for data used by conversational component 111. In the depicted embodiment, database 118 resides on conversational server 110. In another embodiment, database 118 may reside elsewhere within cognitive conversational system data processing environment 100, provided that conversational component 111 has access to database 118. A database is an organized collection of data. Database 118 can be implemented with any type of storage device capable of storing data and configuration files that can be accessed and utilized by conversational server 110, such as a database server, a hard disk drive, or a flash memory. Database 118 uses one or more of a plurality of techniques known in the art to store a plurality of information of such as, but is not limited to, resources (basic and/or extended), domain model, etc. For example, database 118 may store information from website regarding PC troubleshooting discussion. A domain model is a system of abstractions that represents and describes a selected aspects of knowledge or activities. A domain model generally uses the vocabulary of the domain so that a representation of the model can be used to communicate with everyone.

FIG. 1B is a functional block diagram depicting conversational component 111 comprising of candidate resource component 112, reinforcement learning (RL) model component 114 and runtime RL user-interaction component 116.

Candidate resource component 112 of an embodiment of the present invention provides the capability to generate a vector based representation of the incoming language data sources. In an embodiment, candidate resource component 112 can cluster resources (combine a set of extended resources with basic resource) into resource vectors based on their representative capability, that is, calculating the distance (e.g., vector distance) of distributed representation for domain-specific keywords, rather than simple coverage such as words or phrases. Additionally, candidate resource component 112 can calculate the distributed representations of each resource vector, and then apply each resource vector into conversational system, and generate one bot instance based on each resource vector.

In the present embodiment, candidate resource component 112 has the following characteristics:
Generate sample extend resources (e.g., generate vectors based on extended resources such as websites and forums)
generate distributed representation for each sampled extended resource based on the input the extended resources (e.g., for each sampled extended resource, combine the word content from the documents, websites, etc. into one file, and then apply Word2Vec algorithm to generate word vectors)
extract domain specific keywords for domain model and retrieve corresponding distributed representations (e.g., first, extract domain specific keywords from domain mode in parallel to generating a distributed representation for each resource. Second, based on the result of the first step, retrieve distributed representation for each domain-specific keyword, this is for each resource).
cluster sample extended resource and generate candidate resource vectors (e.g., as each resource may not be large, but the number is large, there is a need to put the various resources into a few clusters (each cluster contains a set of resources). As each resource has its own keyword vectors, candidate resource component 112 can compare the similarity (or distance) of every two resources by comparing the keyword vectors)
resource maintenance (e.g., replace/add/remove one resource from a resource cluster)

Below illustrates the difference between basic and extended resource in an interaction example 1:
Basic Resource
   Stand utterance 1: “Insurance types include: damage insurance, scratch insurance, third-party insurance”
   Stand utterance 2: “The third-party insurance is . . . ”
Extended Resource
   Extended utterance 1: “His husband has a third-party”

RL model component 114 of an embodiment of the present invention provides the capability to manage learning effectiveness of the various resources components. In the present embodiment, RL model component has the following characteristics:
train word vectors using resource vectors (e.g., all the resources listed in the resource vector will be combined together into one file, and then apply Word2Vec algorithm to generate work vectors)
build conversational components (e.g., NLC, NER, etc.) using word vectors
establish the relations between resource vectors (e.g., this step is to check whether a resource can be used to replace another resource)
reinforcement learning for resource selection (e.g., apply reinforcement learning to select resources based on the feedback of effectiveness measurement)

Additionally, RL model component 114 has the ability to label and refine resource vectors. For example, labeling and refining a resource vector occurs after the simulation of runtime user interaction based on each bot instance. RL model component 114 establishes the relationship between the resource vectors and applies reinforcement learning to the resource vectors based on the feedback of the effectiveness measurement to further label and refine the resource vectors.

Runtime RL user-interaction component 116 of an embodiment of the present invention provides the capability to manage user interaction during runtime. In addition, runtime RL user-interaction component 116 can simulate or apply runtime user interactions using each bot instance, which is dynamically updated through the reinforcement learning of resource vectors, and then label and refine resource vectors based on reinforcement learning results (e.g., Q-values) through RL model component 114. In the present embodiment, runtime RL user-interaction component 116 has the following characteristics:
conversation engine (e.g., accepts user input, applies Natural Language Understanding to understand user input such as intent and entities, orchestrates other conversation engines to generate response and reply user)
conversation effectiveness measure (e.g., applies automatic test cases to evaluate whether the actions (replace/add/remove one resource from a resource cluster) can improve the effectiveness of the conversational system)

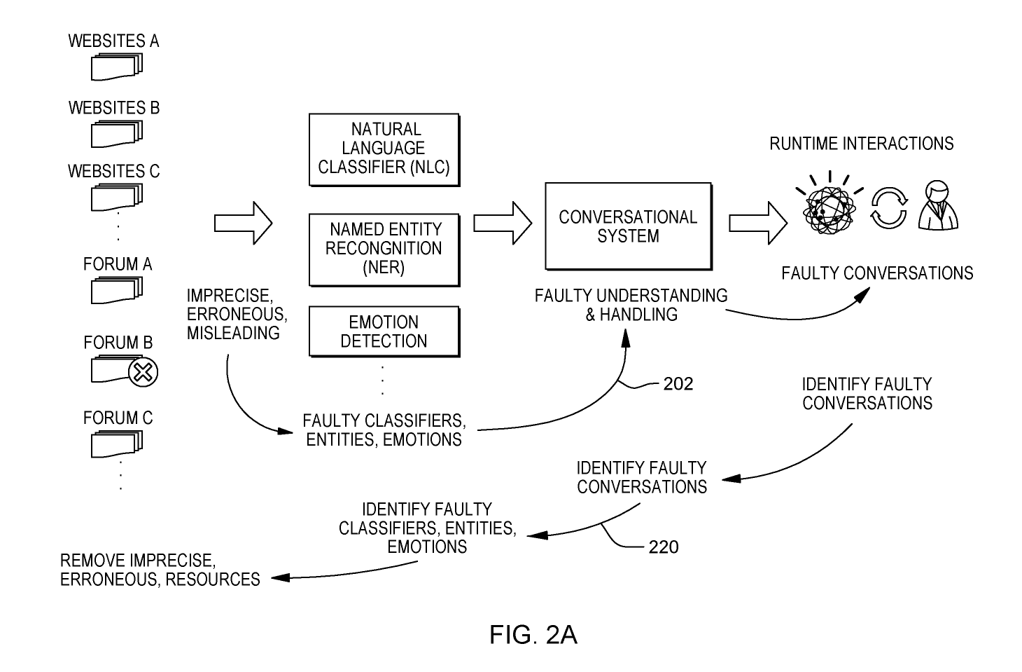

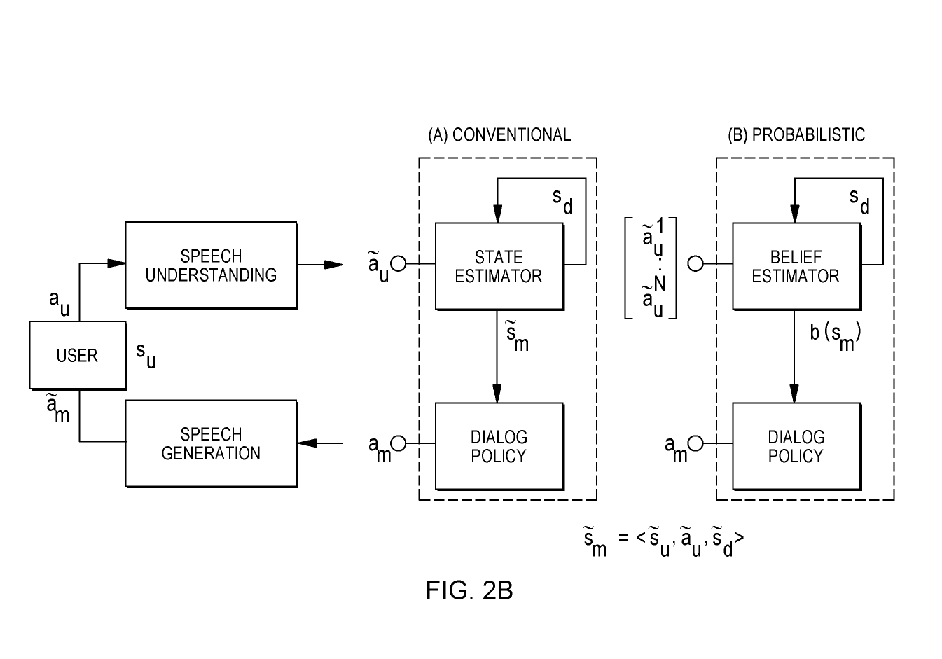

FIG. 2A depicts a typical textual flow illustrating the common issues regarding conversational system in accordance with an embodiment of the present invention. Faulty texts and arrows 202 shows how the imprecise, erroneous, and misleading text may lead to final faulty conversations (this is how errors happen); while precise texts and arrows 220 show that how this invention's approach can identify root cause from the faulty conversations (i.e., this is how to identify the root cause and fix).

FIG. 2B is a diagram illustrating a statistical spoken dialogue system structure, in accordance with an embodiment of the present invention. For example, spoken dialogue system such as Partially Observable Markov Decision Process (POMDP)-based spoken dialogue management or Markov Decision Process (MDP).

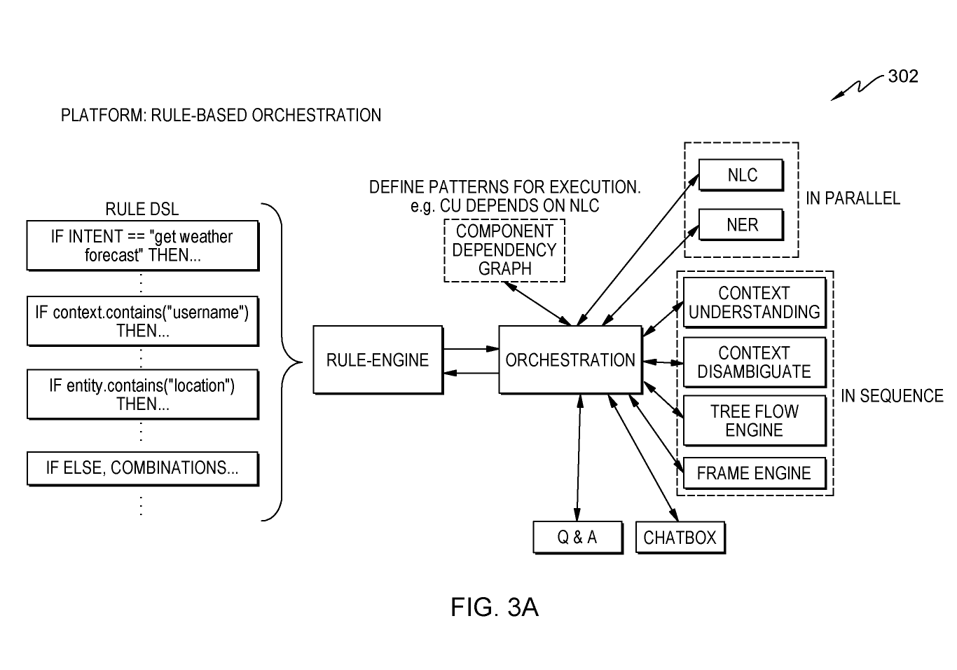

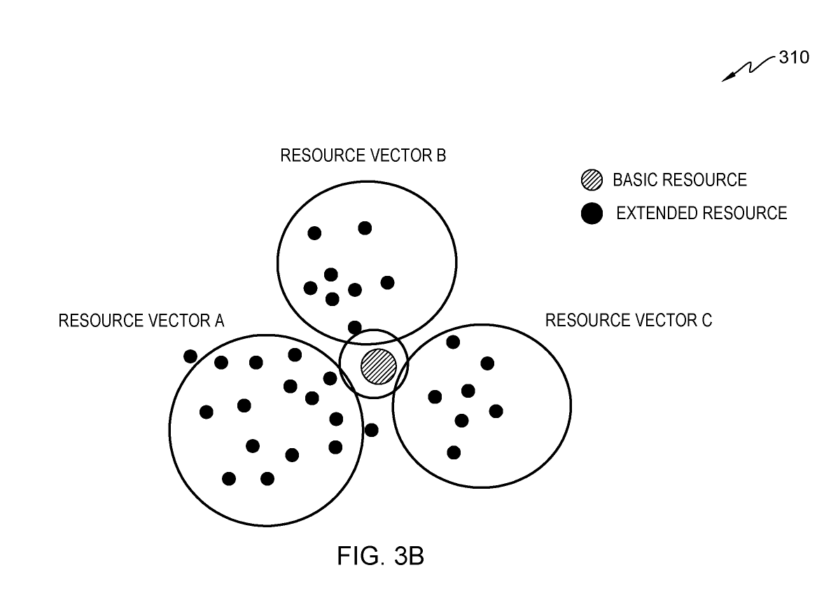

FIG. 3A illustrates a simplified implementation model using rule-based orchestration platform 302 of conversational component 111 in accordance with an embodiment of the present invention.

FIG. 3B is an illustration of resource vector 310, in accordance with an embodiment of the present invention.

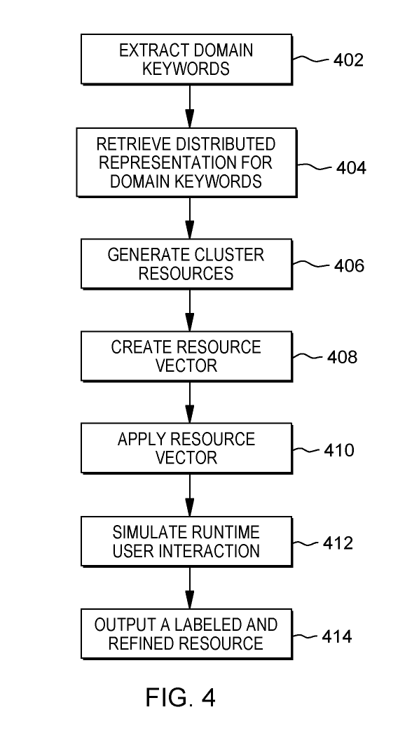

FIG. 4 is a flowchart depicting operational steps of conversational component 111 in accordance with an embodiment of the present invention.

Conversational component 111 extract domain keywords (step 402). In an embodiment, 111 through candidate resource component 112 component extracts domain specific keywords from the domain model.

Conversational component 111 retrieve distributed representation for domain keywords (step 404). In an embodiment, 111 through candidate resource component 112 component retrieve distributed representation for domain keywords.

Conversational component 111 generate cluster resources (step 406). In an embodiment, 111 through candidate resource component 112 component generate clustered resources into resource vectors based on their representative capability on the domain-specific keywords.

Conversational component 111 calculate resource vector (step 408). In an embodiment, 111 through candidate resource component 112 component generate clustered resources into resource vectors based on their representative capability on the domain-specific keywords.

Conversational component 111 apply resource vector (step 410). In an embodiment, 111 through candidate resource component 112 component apply resource vectors to build key components (NLC, NER, etc.) of a conversational system. After applying each resource vector into conversational system, conversation component 111 generates one bot instance based on each resource vector.

Conversational component 111 simulate runtime user interaction (step 412). In an embodiment, 111 through runtime RL user-interaction component 116 component simulate runtime user interaction.

Conversational component 111 outputs a labeled and refined resource keywords (step 414). In an embodiment, conversational component 111 through RL model component 114 outputs a labeled and refined resource vectors based on RL results (e.g., Q-values). The results of this step can be used to identified imprecise and erroneous information in the conversation system and improve the dialogue between the user and supporting technician.

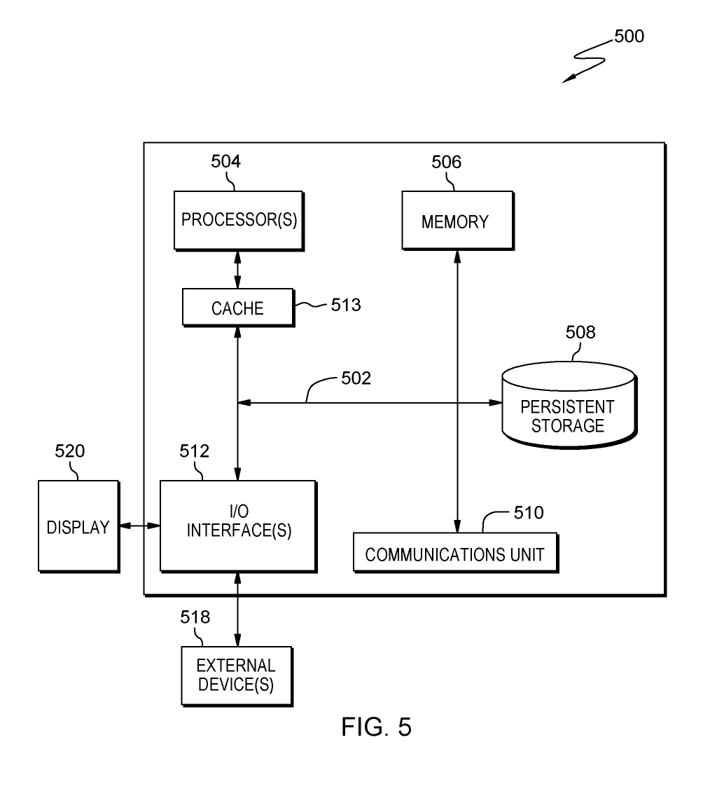

FIG. 5 depicts a block diagram of components of conversational server 110 within cognitive conversational system processing data processing environment 100 of FIG. 1, in accordance with an embodiment of the present invention. It should be appreciated that FIG. 5 provides only an illustration of one implementation and does not imply any limitations with regard to the environments in which different embodiments can be implemented. Many modifications to the depicted environment can be made.

Conversational server 110 can include processor(s) 504, cache 516, memory 506, persistent storage 508, communications unit 510, input/output (I/O) interface(s) 512 and communications fabric 502. Communications fabric 502 provides communications between cache 516, memory 506, persistent storage 508, communications unit 510, and input/output (I/O) interface(s) 512. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses.

Memory 506 and persistent storage 508 are computer readable storage media. In this embodiment, memory 506 includes random access memory (RAM). In general, memory 506 can include any suitable volatile or non-volatile computer readable storage media. Cache 516 is a fast memory that enhances the performance of processor(s) 504 by holding recently accessed data, and data near recently accessed data, from memory 506.

Program instructions and data used to practice embodiments of the present invention, e.g., conversational component 111 and database 118, can be stored in persistent storage 508 for execution and/or access by one or more of the respective processor(s) 504 of conversational server 110 via memory 506. In this embodiment, persistent storage 508 includes a magnetic hard disk drive. Alternatively, or in addition to a magnetic hard disk drive, persistent storage 508 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer readable storage medium that is also part of persistent storage 508.

Communications unit 510, in these examples, provides for communications with other data processing systems or devices. In these examples, communications unit 510 includes one or more network interface cards. Communications unit 510 may provide communications through the use of either or both physical and wireless communications links. Conversational component 111 and database 118 may be downloaded to persistent storage 508 of conversational server 110 through communications unit 510.

I/O interface(s) 512 allows for input and output of data with other devices that may be connected to conversational server 110. For example, I/O interface(s) 512 may provide a connection to external device(s) 518 such as a keyboard, a keypad, a touch screen, a microphone, a digital camera, and/or some other suitable input device. External device(s) 518 can also include portable computer readable storage media such as, for example, thumb drives, portable optical or magnetic disks, and memory cards. Software and data used to practice embodiments of the present invention, e.g., conversational component 111 and database 118 on conversational server 110, can be stored on such portable computer readable storage media and can be loaded onto persistent storage 508 via I/O interface(s) 512. I/O interface(s) 512 also connect to a display 520.

Display 520 provides a mechanism to display data to a user and may be, for example, a computer monitor or the lenses of a head mounted display. Display 520 can also function as a touchscreen, such as a display of a tablet computer.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

1. A computer-implemented method for improving the identification of textual resources that contain unrelated and imprecise contents to improve a user's understanding of a conversational system, the method comprising:
extracting, by one or more computer processors, a domain keyword from a domain model;
retrieving, by the one or more computer processors, a distributed representation associated with the domain keyword;
generating, by the one or more computer processors, a cluster resource based on the distributed representation;
creating, by the one or more computer processors, a resource vector associated with the cluster resource by calculating the resource vector;
generating, by the one or more computer processors, one or more bot instances based on the resource vector;
applying, by the one or more computer processors, the resource vector to a conversational system;
simulating, by the one or more computer processors, a runtime user interaction based on reinforcement learning of the resource vector and based on the one or more bot instances to further label and refine resource vector; and
outputting, by the one or more computer processors, a labeled and refined resource vector to aid in understanding of the conversational system.

2. The computer-implemented method of claim 1, wherein the resource vectors comprises a candidate resource vector.

3. The computer-implemented method of claim 1, wherein generating the cluster resource, further comprises:
comparing, by the one or more computer processors, a size of the cluster resource against a threshold size; and
responsive to the size of the cluster resource exceeding the threshold, combining, by the one or more computer processors, one or more extended resource with one or more basic resource into the cluster resource.

4. The computer-implemented method of claim 1, wherein calculating a resource vector, further comprises calculating a vector distance using the distributed representation for domain-specific keywords against resource vectors.

5. (canceled)

6. The computer-implemented method of claim 1, wherein simulating the runtime user interaction, further comprises user interaction with a simulation and applying automatic test cases to evaluate a result of the simulation.

7. The computer-implemented method of claim 1, wherein labeling and refining the resource vectors further comprises establishing a relationship between the resource vectors and applying reinforcement learning to the resource vectors.

8. A computer program product improving the identification of textual resources that contain unrelated and imprecise contents to improve a user's understanding of a conversational system, the computer program product comprising:
one or more computer readable storage devices and program instructions stored on the one or more computer readable storage devices, the stored program instructions comprising:
program instructions to extract a domain keyword from a domain model;
program instructions to retrieve a distributed representation associated with the domain keyword;
program instructions to generate a cluster resource based on the distributed representation;
program instructions to create a resource vector associated with the cluster resource by calculating the resource vector;
program instructions to generate one or more bot instances based on the resource vector:
program instructions to apply the resource vector to a conversational system;
program instructions to simulate a runtime user interaction based on reinforcement learning of the resource vector to further label and based on the one or more bot instances and refine resource vector; and
program instructions to output a labeled and refined resource vector to aid in understanding of the conversational system.

9. The computer program product of claim 8, wherein the resource vectors comprises a candidate resource vector.

10. The computer program product of claim 8, wherein the program instructions to generate the cluster resource, further comprises:
program instructions to compare a size of the cluster resource against a threshold size; and
responsive to the size of the cluster resource exceeding the threshold, program instructions to combine one or more extended resource with one or more basic resource into the cluster resource.

11. The computer program product of claim 8, wherein the program instructions to calculate a resource vector, further comprises the program instructions to calculate a vector distance using the distributed representation for domain-specific keywords against resource vector.

12. (canceled)

13. The computer program product of claim 8, wherein the program instructions to simulate the runtime user interaction, further comprises user interaction with a simulation and apply automatic test cases to evaluate a result of the simulation.

14. The computer program product of claim 8, wherein the program instructions to label and refine the resource vectors further comprises the program instructions to establish a relationship between the resource vectors and apply reinforcement learning to the resource vectors.

15. A computer system for improving the identification of textual resources that contain unrelated and imprecise contents to improve a user's understanding of a conversational system, the computer system comprising:
one or more computer processors;
one or more computer readable storage devices;
program instructions stored on the one or more computer readable storage devices for execution by at least one of the one or more computer processors, the stored program instructions comprising:
program instructions to extract a domain keyword from a domain model;
program instructions to retrieve a distributed representation associated with the domain keyword;
program instructions to generate a cluster resource based on the distributed representation;
program instructions to create a resource vector associated with the cluster resource by calculating the resource vector;
program instructions to generate one or more bot instances based on the resource vectors;
program instructions to apply the resource vector to a conversational system;
program instructions to simulate a runtime user interaction based on reinforcement learning of the resource vector to further label and based on the one or more bot instances and refine resource vector; and
program instructions to output a labeled and refined resource vector to aid in understanding of the conversational system.

16. The computer system of claim 15, wherein the stored program instructions to generate the cluster resource, further comprises:
program instructions to compare a size of the cluster resource against a threshold size; and
responsive to the size of the cluster resource exceeding the threshold, program instructions to combine one or more extended resource with one or more basic resource into the cluster resource.

17. The computer system of claim 15, wherein the stored program instructions to calculate a resource vector, further comprises the program instructions to calculate a vector distance using the distributed representation for domain-specific keywords against the resource vector.

18. (canceled)

19. The computer system of claim 15, wherein the stored program instructions to simulate the runtime user interaction, further comprises user interaction with a simulation and apply automatic test cases to evaluate a result of the simulation.

20. The computer system of claim 15, wherein the stored program instructions to label and refine the resource vectors further comprises the program instructions to establish a relationship between the resource vectors and apply reinforcement learning to the resource vectors.
